(19) United States
(12) Patent Application Publication
(10) Pub. No.: US 2025/0193754 A1
(43) Pub. Date: Jun. 12, 2025

(54) SATELLITE SWITCH FOR MOBILITY

(71) Applicant: Samsung Electronics Co., Ltd., Suwon-si (KR)

(72) Inventors: Shiyang Leng, Allen, TX (US); Anil Agiwal, McKinney, TX (US); Kyeongin Jeong, Allen, TX (US)

(21) Appl. No.: 18/945,436

(22) Filed: Nov. 12, 2024

Related U.S. Application Data
(60) Provisional application No. 63/607,937, filed on Dec. 8, 2023.
(60) Provisional application No. 63/553,540, filed on Feb. 14, 2024.
(60) Provisional application No. 63/554,703, filed on Feb. 16, 2024.
(60) Provisional application No. 63/678,249, filed on Aug. 1, 2024.

(51) Int. Cl. H04W 36/08; H04W 56/00; H04W 74/00; H04W 84/06

(52) U.S. Cl. CPC H04W 36/083; H04W 56/0045; H04W 74/004; H04W 84/06

(57) ABSTRACT

The disclosure provides a method performed by a user equipment (UE) in a wireless network. The UE receives, from a base station, a configuration associated with a satellite switch. The UE performs the satellite switch with re-synchronization from a source satellite to a target satellite based on the configuration. The UE generates a satellite switch completion indication. The UE transmits, to the base station, the satellite switch completion indication. The satellite switch completion indication is generated based on a determination that uplink synchronization is obtained for the target satellite due to the satellite switch with re-synchronization.

### CROSS-REFERENCE TO RELATED APPLICATIONS

This application claims the benefit of priority from U.S. Provisional Application No. 63/607,937 entitled “CSI REPORT ACTIVATION FOR MOBILITY,” filed Dec. 8, 2023; U.S. Provisional Application No. 63/553,540 entitled “CSI REPORT ACTIVATION FOR MOBILITY,” filed Feb. 14, 2024; U.S. Provisional Application No. 63/554,703 entitled “REPORT OF SATELLITE SWITCH COMPETION,” filed Feb. 16, 2024; and U.S. Provisional Application No. 63/678,249 entitled “REPORT OF SATELLITE SWITCH COMPETION,” filed Aug. 1, 2024, all which are incorporated herein by reference in their entirety.

### TECHNICAL FIELD

This disclosure relates generally to a wireless communication system, and more particularly to, for example, but not limited to, a satellite switch for mobility in a wireless communication system.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the disclosure provides a user equipment (UE) for facilitating communication in a wireless network. The UE comprises a transceiver configured to receive, from a base station, a configuration associated with a satellite switch. The UE comprises a processor operably coupled to the transceiver. The processor is configured to perform the satellite switch with re-synchronization from a source satellite to a target satellite based on the configuration and to generate a satellite switch completion indication. The transceiver is further configured to transmit, to the base station, the satellite switch completion indication.

In some embodiments, the satellite switch completion indication is generated based on a determination that uplink synchronization is obtained for the target satellite due to the satellite switch with re-synchronization.

In some embodiments, the processor is further configured to trigger a scheduling request based on a determination that an uplink shared channel resource does not accommodate the satellite switch completion indication. The transceiver is further configured to transmit, to the base station, the scheduling request.

In some embodiments, the satellite switch completion indication is a timing advance report.

In some embodiments, the satellite switch completion indication is included in a medium access control (MAC) control element (CE) that is identified by a logical channel identifier or an extended logical channel identifier of a MAC subheader.

In some embodiments, the transceiver is further configured to transmit the MAC CE in a prioritized logical channel.

In some embodiments, the satellite switch completion indication is generated based on a determination that a difference in a timing advance value from a last timing advance report is larger than an offset value.

In some embodiments, the transceiver is further configured to receive an indication from the base station via a radio resource control (RRC) signaling, the indication enabling transmission of the satellite switch completion indication.

An aspect of the disclosure provides a base station (BS) for facilitating communication in a wireless network. The BS comprises a processor configured to generate a configuration associated with a satellite switch. The BS comprises a transceiver operably coupled to the processor. The transceiver is configured to transmit, to a user equipment (UE), the configuration. The transceiver is configured to receive, from the UE, a satellite switch completion indication indicating that the satellite switch with re-synchronization from a source satellite to a target satellite is completed.

In some embodiments, the satellite switch completion indication indicates that uplink synchronization is obtained for the target satellite due to the satellite switch with re-synchronization.

In some embodiments, the transceiver is further configured to receive, from the UE, a scheduling request for accommodating the satellite switch completion indication.

In some embodiments, the satellite switch completion indication is a timing advance report.

In some embodiments, the satellite switch completion indication is included in a medium access control (MAC) control element (CE) that is identified by a logical channel identifier or an extended logical channel identifier of a MAC subheader.

In some embodiments, the transceiver is further configured to receive the MAC CE in a prioritized logical channel.

In some embodiments, the satellite switch completion indication indicates that a difference in a timing advance value from a last timing advance report is larger than an offset value.

In some embodiments, the transceiver is further configured to transmit an indication to the UE via radio resource control (RRC) signaling, the indication enabling transmission of the satellite completion indication by the UE.

An aspect of the disclosure provides a method performed by a user equipment (UE) in a wireless network. The method comprises receiving, from a base station, a configuration associated with a satellite switch. The method comprises performing the satellite switch with re-synchronization from a source satellite to a target satellite based on the configuration. The method comprises generating a satellite switch completion indication. The method comprises transmitting, to the base station, the satellite switch completion indication.

In some embodiments, the satellite switch completion indication is generated based on a determination that uplink synchronization is obtained for the target satellite due to the satellite switch with re-synchronization.

In some embodiments, the method further comprises transmitting a scheduling request based on a determination that an uplink shared channel resource does not accommodate the satellite switch completion indication.

In some embodiments, the satellite switch completion indication is generated based on a determination that a difference in a timing advance value from a last timing advance report is larger than an offset value.

### BRIEF DESCRIPTION OF THE DRAWINGS

FIG. 1 shows an example of a wireless network in accordance with an embodiment of the present disclosure.

FIG. 2A shows an example of a wireless transmit path in accordance with an embodiment of the present disclosure.

FIG. 2B shows an example of a wireless receive path in accordance with an embodiment of the present disclosure.

FIG. 3A shows an example of a user equipment (“UE”) in accordance with an embodiment of the present disclosure.

FIG. 3B shows an example of a base station (“BS”) in accordance with an embodiment.

FIG. 4 shows an example MAC subheader with LCID for SP CSI reporting on PUCCH Activation/Deactivation MAC CE in accordance with an embodiment of the present disclosure.

FIG. 5 shows an example of SP CSI reporting on PUCCH Activation/Deactivation MAC CE in accordance with an embodiment of the present disclosure.

FIG. 6 shows another example of SP CSI reporting on PUCCH Activation/Deactivation MAC CE in accordance with an embodiment of the present disclosure.

FIG. 7 shows an example of an LTM SP CSI reporting on PUCCH Activation/Deactivation MAC CE in accordance with an embodiment of the present disclosure.

FIG. 8 shows another example MAC subheader with a new eLCID in accordance with an embodiment of the present disclosure.

FIG. 9 shows an example process for a satellite switch with re-synchronization in accordance with an embodiment of the present disclosure.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

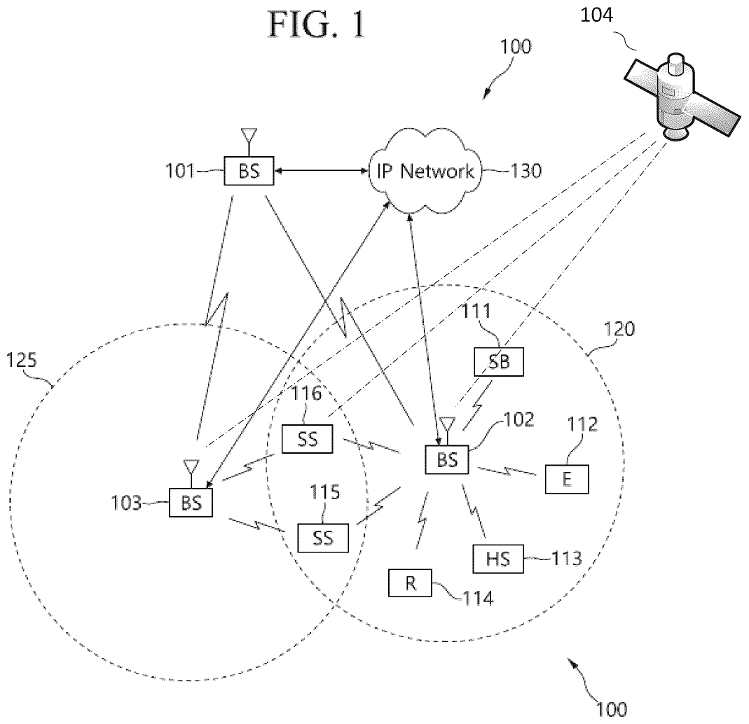

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs can also be on board the communication satellite(s) 104. Various of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for implementing satellite switch for mobility in wireless networks. In certain embodiments, one or more of the BSs 101-103 include circuitry, programing, or a combination thereof to support satellite switch for mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

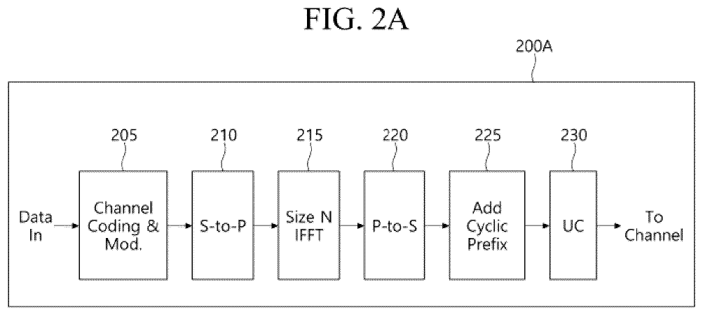

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support satellite switch for mobility in wireless networks as described in embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

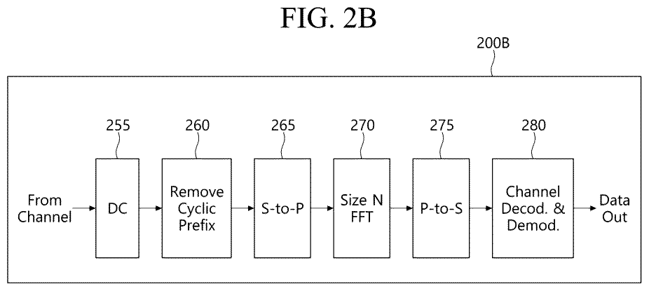

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes for satellite switch for mobility in wireless networks as described in embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support satellite switch for mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP TS 38.300 v18.1.0; ii) 3GPP TS 38.331 v18.1.0; and iii) 3GPP TS 38.321 v18.1.0.

3GPP (Third-Generation Partnership Project) has developed technical specifications and standards to define the new 5G radio-access technology, known as 5G NR (new radio). In Release 18 specifications, including non-terrestrial network (NTN) enhancement, a satellite switch without physical cell identifier (PCI) change is considered. This requires beam-level mobility without layer 3 (L3) mobility. However, when switching to a target satellite, UE needs to perform UL synchronization by random access procedure or by random access channel (RACH)-less procedure when the target satellite is available.

In both a hard satellite switch and a soft satellite switch in a quasi-earth fixed scenario, with the same SSB (synchronization signal/physical broadcast channel block) frequency and the same BS, the satellite switch with re-synchronization is supported. The satellite switch with re-synchronization can avoid L3 mobility for UE in the cell by maintaining the same PCI on the geographical area covered by quasi-earth fixed beam. For the soft satellite switch, UE can start synchronization with a target satellite before a source satellite ends its service to the cell. It is not required for UE to remain connected to the source satellite when switching to the target cell. In contrast, for the hard satellite switch, UE can only begin synchronization with the target cell after the source satellite has stopped providing the service to the cell. It is required for UE to maintain its connection with the source satellite until the switch to the target cell is initiated.

In the conventional wireless system, for a satellite switch with re-synchronization and unchanged PCI, UE autonomously switches to a target satellite based on a network indication of a soft satellite switch or a hard satellite switch, without a random access procedure. However, if there is no immediate UL data transmission, the network may not know exactly when UE has completed the satellite switch, whether the switch was successful, or when to begin scheduling UE from the new satellite (target satellite). Even in a lower layer switch without L3 involvement, the network should be aware of UE's intra-cell inter-satellite mobility for network control in RRC_CONNECTE state as the satellite switch is involved. Therefore, UE should inform the network of the completion of the satellite switch with re-synchronization and unchanged PCI. The satellite switch procedure can be enhanced by considering overlapping service time of the source satellite and the target satellite.

For mobility in connected mode, a handover is initiated by the network via higher layer signaling, such as an RRC message, based on Layer 3 (L3) measurements. However, this procedure introduces additional latency, signaling overhead, and interruption time, which can become critical in scenarios with frequent handover, such as high-speed vehicular environments and frequency range (FR) 2 deployment. To address these challenges, it is necessary to reduce the overhead, latency, and interruption time associated with the handover. This brings the need of Layer 1/Layer 2 (L1/L2) Triggered Mobility (LTM), where the handover can be triggered by L1/L2 signaling based on L1 measurement. More specifically, LTM refers to a mobility mechanism in which UE switches from a source cell to a target cell through beam switching, triggered by L1/L2 signaling. The beam switching decision is based on L1 measurement of beams among neighboring cells.

The UE performs L1 measurement and reports channel state information (CSI) measurements to the network, based on which network determines the target cell for the cell switch. The measurement report may be configured in various ways, including periodic, semi-persistent, and aperiodic. For semi-persistent CSI reporting on physical uplink control channel (PUCCH), activating the measurement reporting is required.

The present disclosure provides various embodiments of UE reporting the completion of satellite switch with re-synchronization, which can also be applicable to reporting the completion of a beam switch, a TRP switch, or cell switch in TN or NTN with re-synchronization to a target beam, a target TRP, or a target cell. An enhanced procedure is disclosed enabling UEs to detect SSBs from a target satellite and obtain DL synchronization with the target satellite before ending communication with the source satellite, which can also be applicable to reporting the completion of a beam switch, a TRP switch, or a cell switch in TN or NTN with re-synchronization to a target beam, a target TRP, or a target cell. In this disclosure, “satellite switch” can be replaced by “a beam switch,” “a TRP switch,” or “a cell switch.” Additionally, the present disclosure provides various embodiments of signaling to activate semi-persistent CSI reporting on PUCCH for LTM.

In the lower layer switch, it is appropriate to report the completion of satellite switch in the MAC procedure. In some embodiments, UE reports a timing advance (TA) to a target satellite as a signal of satellite switch completion. In an embodiment, in the TA report procedure, a timing advance report (TAR) is triggered by an upper layer indication or when TA difference from the last report exceeds a predetermined offset. A scheduling request (SR) for the TAR can be enabled through RRC configuration. In another embodiment, in order to signal the completion of satellite switch, the TAR can be triggered towards the target satellite regardless of the TA difference from the last report or upper layer indication or configuration on the TAR. When an indication of uplink synchronization is received after an indication of uplink synchronization loss due to the satellite switch with re-synchronization, the TAR may be triggered to signal the completion of the satellite switch.

In some embodiments, in order to signal the completion of the satellite switch, a SR for TAR MAC control element (CE) may be triggered when a TAR has not been sent after the satellite switch. When an indication of uplink synchronization is obtained following an indication of uplink synchronization loss due to a satellite switch with re-synchronization, and UE has not reported TA after the satellite switch with re-synchronization, the SR may be triggered if there is no UL grant for the triggered TAR. In some other embodiments, an RRC message, a MAC CE, or an indication in a physical control channel (e.g., in DCI carried by PDCCH) can be used to signal the completion of a satellite switch, a beam switch, a TRP switch, or a cell switch.

In some embodiments, a MAC entity in a UE may operate for each serving cell as follows:
1> if an indication of uplink synchronization has been received from an upper layer:
   2> if indication of uplink synchronization is received after indication of uplink synchronization loss due to satellite switch with re-synchronization:
      3> set a timing advance value (N_{TA}) to zero for primary timing advance group (PTAG);
      3> indicate to lower layers a Differential Koffset with value zero;
      3> trigger a TAR.
   2> allow uplink transmission on the serving cell.

In some embodiments, a TAR may be triggered if any of the following events occur:
Upon receiving an indication from an upper layer to trigger a TAR;
Upon receiving a configuration of offsetThresholdTA by the upper layer, if UE has not previously reported TA value to current serving cell;
if the variation between the current estimate of the TA value and the last reported TA value is equal to or larger than offsetThresholdTA, if configured; or
if an indication of uplink synchronization is received after an indication of uplink synchronization loss due to satellite switch with re-synchronization.

In some embodiments, the MAC entity in the UE may operate as follows:
1> if the TAR procedure determines that at least one TAR has been triggered and not cancelled:
   2> if uplink shared channel (UL-SCH) resources are available for a new transmission and the UL-SCH resources can accommodate the TAR MAC CE plus its subheader as a result of logical channel prioritization:
      3>instruct a multiplexing and assembly procedure to generate the TAR MAC CE.
   2> else:
      3> if timingAdvanceSR is configured with value enabled, or
      3> if indication of uplink synchronization is received after indication of uplink synchronization loss due to satellite switch with re-synchronization and TA value has not been reported after satellite switch with re-synchronization:
         4>trigger a scheduling request (SR).

In some embodiments, a new MAC CE may be introduced. It may be referred to, for example, as Satellite Switch with Re-sync Completion Report MAC CE. The new MAC CE may be identified by a MAC sub-header with a new logical channel ID (LCID) or a new extended LCID (EICID). The MAC CE may have a fixed size of zero bits. In an implementation, values of LCID for UL-SCH are as shown in Table 1 when the LCID extension (LX) is not applied. In the example of Table 1, the Satellite Switch with Re-sync Completion Report MAC CE may have a Codepoint/Index value of 42.

TABLE 1

| Codepoint/ | |
|---|---|
| Index | LCID values |
| 0 | CCCH of size 64 bits, except for an (e)RedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits for a RedCap UE |
| 36 | CCCH of size 64 bits for a RedCap UE |
| 37 | SL LBT failure |
| 38-41 | Reserved |
| 42 | Satellite Switch with Re-sync Completion Report |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits, except for an (e)RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

NOTE:
CCCH of size 48 bits and CCCH of size 64 bits are referred to as CCCH and CCCH1, respectively, in TS 38.331.

In another implementation, values of LCID for UL-SCH may be as shown in Table 2 when the LX is applied. In the example of Table 2, the Satellite Switch with Re-sync Completion Report MAC CE may have a codepoint of 8 and an index of (2¹⁶+328).

TABLE 2

| Codepoint | Index | LCID values |
|---|---|---|
| 0 | (2¹⁶ + 320) | CCCH of size 48 bits |
| | | for an eRedCap UE |
| 1 | (2¹⁶ + 321) | CCCH of size 64 bits |
| | | for an eRedCap UE |
| 2 | (2¹⁶ + 322) | CCCH of size 48 bits for |
| | | PUCCH repetition of Msg4 |
| | | HARQ-ACK, except for |
| | | an (e)RedCap UE |
| 3 | (2¹⁶ + 323) | CCCH of size 64 bits for |
| | | PUCCH repetition of Msg4 |
| | | HARQ-ACK, except for |
| | | an (e)RedCap UE |
| 4 | (2¹⁶ + 324) | CCCH of size 48 bits for |
| | | PUCCH repetition of Msg4 |
| | | HARQ-ACK of a RedCap UE |
| 5 | (2¹⁶ + 325) | CCCH of size 64 bits for |
| | | PUCCH repetition of Msg4 |
| | | HARQ-ACK of a RedCap UE |
| 6 | (2¹⁶ + 326) | CCCH of size 48 bits for |
| | | PUCCH repetition of Msg4 |
| | | HARQ-ACK of an eRedCap UE |
| 7 | (2¹⁶ + 327) | CCCH of size 64 bits for |
| | | PUCCH repetition of Msg4 |
| | | HARQ-ACK of an eRedCap UE |
| 8 | (2¹⁶ + 328) | Satellite Switch with |
| | | Re-sync Completion Report |
| 9 to 63 | (2¹⁶ + 329) to (2¹⁶ + | Reserved |
| | 383) | |

NOTE 1:
The MAC entity may use the code point corresponding to a given feature or feature combination in Table 6.2.1-2c only if network indicates support for the corresponding feature or feature combination.
NOTE 2:
CCCH of size 48 bits and CCCH of size 64 bits are referred to as CCCH and CCCH1, respectively, in TS 38.331.

In another implementation, values of one-octet eLCID for UL-SCH may be as shown in Table 3. The Satellite Switch with Re-sync Completion Report MAC CE may have a codepoint of value X and an index of value Y. In the example of Table 3, the Satellite Switch with Re-sync Completion Report MAC CE may have a codepoint of 222 and an index of 286.

TABLE 3

| Codepoint | Index | LCID values |
|---|---|---|
| 0 to 221 | 64 to 285 | Reserved |
| 222 | 286 | Satellite Switch with Re-sync |
| | | Completion Report |
| 223 | 287 | Multiple Entry PHR with assumed |
| | | PUSCH MAC CE (four octets Cᵢ) |
| 224 | 288 | Multiple Entry PHR with assumed |
| | | PUSCH MAC CE (one octets Cᵢ) |
| 225 | 289 | Single Entry PHR with assumed |
| | | PUSCH MAC CE |
| 226 | 290 | SL-PRS Resource Request |
| 227 | 291 | Refined Long BSR |
| 228 | 292 | Delay Status Report |
| 229 | 293 | Enhanced Multiple Entry PHR for |
| | | multiple TRP (four octets Cᵢ) |
| 230 | 294 | Enhanced Multiple Entry PHR for |
| | | multiple TRP (one octets Cᵢ) |
| 231 | 295 | Enhanced Single Entry PHR for |
| | | multiple TRP |
| 232 | 296 | Enhanced Multiple Entry PHR (four |
| | | octets Cᵢ) |
| 233 | 297 | Enhanced Multiple Entry PHR (one |
| | | octets Cᵢ) |
| 234 | 298 | Enhanced Single Entry PHR |
| 235 | 299 | Enhanced BFR (one octet Cᵢ) |
| 236 | 300 | Enhanced BFR (four octet Cᵢ) |
| 237 | 301 | Truncated Enhanced BFR (four octet |
| | | Cᵢ) |
| 238 | 302 | Positioning Measurement Gap |
| | | Activation/Deactivation Request |
| 239 | 303 | IAB-MT Recommended Beam |
| | | Indication |
| 240 | 304 | Desired IAB-MT PSD range |
| 241 | 305 | Desired DL Tx Power Adjustment |
| 242 | 306 | Case-6 Timing Request |
| 243 | 307 | Desired Guard Symbols for Case 6 |
| | | timing |
| 244 | 308 | Desired Guard Symbols for Case 7 |
| | | timing |
| 245 | 309 | Extended Short Truncated BSR |
| 246 | 310 | Extended Long Truncated BSR |
| 247 | 311 | Extended Short BSR |
| 248 | 312 | Extended Long BSR |
| 249 | 313 | Extended Pre-emptive BSR |
| 250 | 314 | BFR (four octets Cᵢ) |
| 251 | 315 | Truncated BFR (four octets Cᵢ) |
| 252 | 316 | Multiple Entry Configured Grant |
| | | Confirmation |
| 253 | 317 | Sidelink Configured Grant |
| | | Confirmation |
| 254 | 318 | Desired Guard Symbols |
| 255 | 319 | Pre-emptive BSR |

In some embodiments, in order to signal the completion of the satellite switch, the Satellite Switch with Re-sync Completion Report MAC CE may be triggered toward the new (target) satellite. When an indication of uplink synchronization is received after an indication of uplink synchronization loss due to the satellite switch with re-synchronization, the Satellite Switch with Re-sync Completion Report MAC CE is triggered to signal the competition of the satellite switch.

In some embodiments, in order to signal or inform the completion of the satellite, a SR for the Satellite Switch with Re-sync Completion Report MAC CE can be triggered when the MAC CE has not been sent after the satellite switch. When an indication of uplink synchronization is received following an indication of uplink synchronization loss due to the satellite switch with re-synchronization, and UE has not sent the Satellite Switch with Re-sync Completion Report MAC CE, a SR can be triggered if there is no UL grant for the triggered MAC CE.

In some embodiments, a MAC entity in a UE may operate for each serving cell as follows:
1> if an indication of uplink synchronization has been received from an upper layer:
   2> if an indication of uplink synchronization is received after indication of uplink synchronization loss due to satellite switch with re-synchronization:
      3> set N_{TA} value to zero for PTAG;
      3>indicate to lower layers a Differential Koffset with value zero;
      3>instruct a multiplexing and assembly procedure to generate Satellite Switch with Re-sync Completion Report MAC CE.
   2>allow uplink transmission on the serving cell.

In some embodiments, logical channels may be prioritized in accordance with the following order (highest priority listed first), where the Satellite Switch with Re-sync Completion Report MAC CE is prioritized:
MAC CE for Cell Radio Network Temporary Identifier (C-RNTI), or data from UL-Common Control Channel (CCCH);
MAC CE for (Enhanced) Beam Failure Recovery (BFR), or MAC CE for Configured Grant Confirmation, or MAC CE for Multiple Entry Configured Grant Confirmation, or MAC CE for Satellite Switch with Re-sync Completion Report;
MAC CE for Sidelink (SL) Configured Grant Confirmation.

In some embodiments, logical channels may be prioritized in accordance with the following order (highest priority listed first), where the Satellite Switch with Re-sync Completion Report MAC CE is prioritized:
MAC CE for C-RNTI, or data from UL-CCCH;
MAC CE for (Enhanced) BFR, or MAC CE for Configured Grant Confirmation, or MAC CE for Multiple Entry Configured Grant Confirmation;
MAC CE for Sidelink Configured Grant Confirmation;
MAC CE for Listen Before Talk (LBT) failure;
MAC CE for SL LBT failure;
MAC CE for Timing Advance Report, or MAC CE for Satellite Switch with Re-sync Completion Report;
MAC CE for Delay Status Report.

In some embodiments, the prioritization among MAC CEs with the same priority may be determined by the UE implementation.

In some embodiments, a Satellite Switch with Re-sync Completion Report MAC CE may trigger a SR if there is no UL grant to accommodate the MAC CE. In an embodiment, any SR configuration may be used for the Satellite Switch with Re-sync Completion Report MAC CE.

In some embodiments, a MAC entity in a UE may operate for each serving cell as follows:
1> if an indication of uplink synchronization has been received from an upper layers:
   2> if indication of uplink synchronization is received after indication of uplink synchronization loss due to satellite switch with re-synchronization:
      3> set N_{TA} value to zero for PTAG;
      3>indicate to lower layers a Differential Koffset with value zero;
      3> if UL-SCH resources are available for a new transmission and the UL-SCH resources can accommodate the TAR MAC CE plus its subheader as a result of logical channel prioritization:
         4>instruct a multiplexing and assembly procedure to generate the Satellite Switch with Re-sync Completion Report MAC CE;
      3> else:
         4>trigger a scheduling request (SR).
   2>allow uplink transmission on the serving cell.

In some embodiments, the MAC entity in the UE may operate for each pending SR which is not triggered according to a buffer status report (BSR) procedure for the serving cell:
1> if this SR was triggered by Satellite Switch with Re-sync Completion Report MAC CE and all the triggered Satellite Switch with Re-sync Completion Report are cancelled; or
   2>cancel the pending SR and stop the corresponding sr-ProhibitTimer, if running.

In some embodiments, the MAC entity in the UE may stop ongoing random access procedure due to a pending SR for the Satellite Switch with Re-sync Completion Report MAC CE, which has no valid PUCCH resources configured, if:
a MAC Protocol Data Unit (PDU) is transmitted using a UL grant other than a UL grant provided by random access response or a UL grant for the transmission of the MSGA (MsgA) payload. The PDU includes a Satellite Switch with Re-sync Completion Report MAC CE.

In some embodiments, in a soft satellite switch, a target satellite may start to serve a serving cell's coverage area before a t-Service, which is an example of service stop time of the source satellite. The target satellite may be one of the satellites providing service to neighbor cells in SIB 19. In an embodiment, ephemeris of the target cell is included in NIN-NeighCellConfig and it may not be duplicated in IE SatSwitchWithReSync. Also, other cell-specific parameters in NTN-Config (e.g., cellSpecificKoffset, ta-Info) may be necessary. To avoid duplicated ephemeris, an index indicating the ephemeris of the neighbor cell may be included in IE SatSwitchWithReSync.

In some embodiments, t-Service parameter indicates the time information on when a cell provided via NTN quasi-earth fixed system is going to stop serving the area it is currently covering. The parameter applies for both the service link switch in NTN quasi-earth fixed system and the feeder link switch for both NTN quasi-earth fixed system and earth-moving system. The parameter indicates a time in multiples of 10 ms after 00:00:00 on Gregorian calendar date Jan. 1, 1900 (midnight between Sunday, Dec. 31, 1899, and Monday, Jan. 1, 1900). The indicated time is referenced at the uplink time synchronization reference point. In an embodiment, UE may consider the propagation delay between UE and RP when determining the UTC time at the UE. The exact stop time may be between the time indicated by the value of the field minus 1 and the time indicated by the value of this parameter. In some embodiments, UE may receive the t-service parameter included in an RRC IE, such as SIB 19. UE may initiate satellite switch with resynchronization based on a time indicated by the t-service parameter broadcasted in SIB 19.

In some embodiments, an RRC parameter, such as targetSatEphemeris, may be included in IE SatSwitchWithReSync in SIB19. The RRC parameter targetSatEphemeris may indicate a neighbour cell in ntn-NeighCellConfigList and ntn-NeighCellConfigListExt. The ephemeris of the indicated neighbor cell is applied to the target satellite. In an implementation, values 0 to 3 of the targetSatEphemeris may indicate neighbor cells in the ordinal position in ntn-NeighCellConfigList, and the value 4 to 7 of the targetSatEphemeris may indicate neighbor cells in the ordinal position in ntn-NeighCellConfigListExt. This RRC parameter is present when the ephemerisInfo in ntn-Config in satSwitchWithReSync is absent. This RRC parameter can be optional present with Need code R.

In some embodiments, a RACH-less handover is supported in NTNs. The RRCReconfiguration message triggering the RACH-less handover may include a timing adjustment indication. Additionally, the RRCReconfiguration message may include a configured grant or a beam indication for accessing the target cell without RACH. UE synchronizes with the target cell by applying the timing adjustment indication and transmits the RRCReconfigurationComplete message using the configured grant. If the configured grant is not included, UE obtains an uplink grant by monitoring PDCCH according to the beam indication.

In some embodiments, when the t-Service of the serving cell is present and SatSwitchWithRe Sync is absent in SIB 19, and UE supports time-based measurement initiation, UE performs intra-frequency, inter-frequency or inter-RAT measurements before the t-Service, regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ. The Srxlev refers to cell selection RX level value (e.g., RSRP, dBm), and Squal refers to cell section quality value (e.g., RSRQ, dB). The SIntraSearchP refers to a threshold of current cell Srxlev to perform intra-frequency. If the current cell Srxleve is lower than this value, UE perform measurement for intra-frequency. The SIntraSearchQ refers to a threshold of current cell Squal to perform intra-frequency. If the current cell Squal is lower than this value, UE perform measurement for intra-frequency. The SnonIntraSearchP refers to a threshold of current cell Srxlev to perform inter-frequency or interRAT measurement. If the current cell Srxleve is lower than this value, UE perform measurement for inter-frequency or interRAT cells. The SnonIntraSearchQ refers to threshold of current cell Squal to perform inter-frequency or interRAT measurement. If the current cell Srqual is lower than this value, UE perform measurement for inter-frequency or inter-RAT cells. The exact time to start measurement before t-Service is up to UE implementation. UE may perform measurements of higher priority NR inter-frequency or inter-RAT frequencies regardless of the remaining service time of the serving cell (i.e. time remaining until t-Service).

When the t-Service of the serving cell is present and SatSwitchWithReSync is present in SIB 19, the UE may skip intra-frequency, inter-frequency or inter-RAT measurements before the t-Service in accordance with the measurement rules for cell re-selection.

In some embodiments, a MAC CE is used to activate semi-persistent (SP) CSI report on PUCCH for LTM. In an embodiment, a SP CSI reporting on PUCCH Activation/Deactivation MAC CE 500 is used to activate the SP CSI reporting.

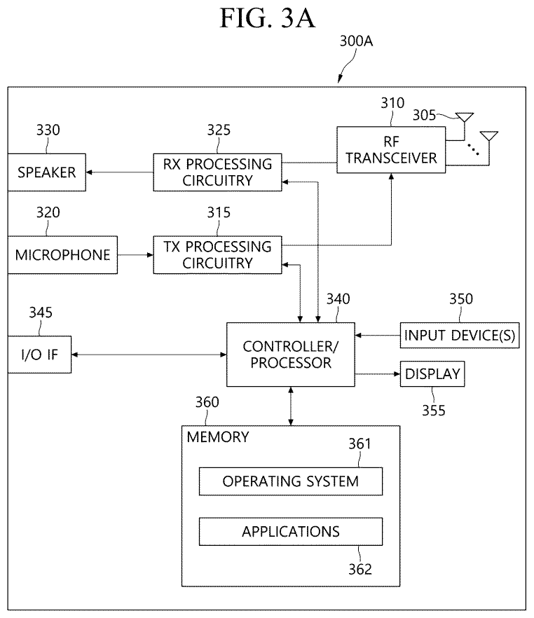

FIG. 4 shows an example MAC subheader with LCID for SP CSI reporting on PUCCH Activation/Deactivation MAC CE 400 in accordance with an embodiment.

Referring to FIG. 4, the MAC subheader 400 includes 2 bits reserved (R) bits and an LCID field, which is 6 bits in size. The LCID field identifies the logical channel instance of the corresponding MAC Service Data Unit (SDU) or the type of the corresponding MAC CE or padding for the DL-SCH and UL-SCH. Table 4 shows example values of LCID for DL-SCH. In the example of Table 4, the LCID for SP CSI reporting on PUCCH Activation/Deactivation MAC CE is specified by codepoint/index 51. If the LCID field is set to 34, one additional octet is present in the MAC subheader, containing the eLCID field following the octet containing LCID field. If the LCID field is set to 33, two additional octets are present in the MAC subheader, containing the eLCID field and these two additional octets following the octet containing LCID field.

TABLE 4

| Codepoint/Index | LCID values |
|---|---|
| 0 | CCCH |
| 1-32 | Identity of the logical channel of DCCH, DTCH and |
| | multicast MTCH |
| 33 | Extended logical channel ID field (two-octet eLCID |
| | field) |
| 34 | Extended logical channel ID field (one-octet eLCID |
| | field) |
| 35-46 | Reserved |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific |
| | PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

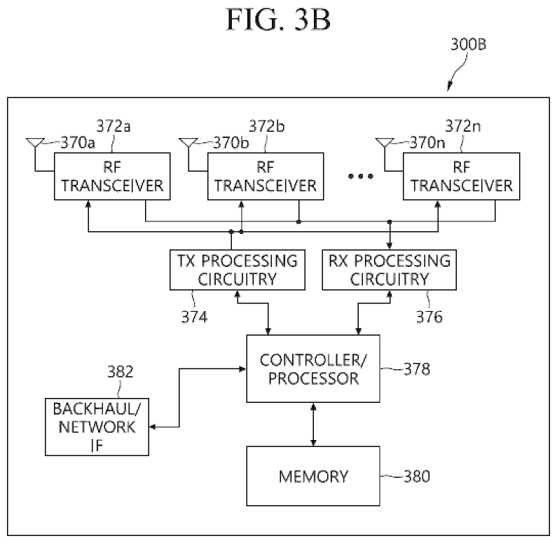

FIG. 5 shows an example of SP CSI reporting on PUCCH Activation/Deactivation MAC CE 500 in accordance with an embodiment.

Referring to FIG. 5, the SP CSI reporting on PUCCH Activation/Deactivation MAC CE 500 has a fixed size of 16 bits and includes an M field, a Cell ID field, a bandwidth part (BWP) ID field, R fields, and Sᵢ fields.

The M field indicates whether the MAC CE 500 is used for SP CSI reporting on PUCCH Activation/Deactivation for a serving cell or for an LTM candidate cell. If LTM is configured by a higher layer, this field is set to 1 to indicate that the MAC CE 500 is used for SP CSI reporting on PUCCH Activation/Deactivation for an LTM candidate cell indicated by the Cell ID field. Otherwise, this field is set to 0 to indicate that the MAC CE 500 is used for SP CSI reporting on PUCCH Activation/Deactivation for a serving cell indicated by the Cell ID field. If LTM is not configured by the higher layer, R bit is present instead. The length of this field is 1 bit. The M field can be referred to ‘LTM indication field’ in this disclosure.

The Cell ID field identifies the cell for which the MAC CE 500 applies. The length of the field is 5 bits. If the LTM indication field indicates that the MAC CE 500 is used for an LTM candidate cell, the 3 least significant bits (LSBs) of the Cell ID field indicates the LTM candidate cell identity, which corresponds to ltm-CandidateId minus 1 as specified in TS 38.331, for which the MAC CE 500 applies. In this case, the 2 most significant bits (MSBs) of the Cell ID field are set to 0. Otherwise (i.e., if LTM is configured by the higher layer and the LTM indication field indicates that the MAC CE 500 is used for a serving cell, or if LTM is not configured by the higher layer), the Cell ID field identifies the serving cell with 5 bits for which the MAC CE 500 applies.

If the LTM indication field indicates that the MAC CE 500 is used for an LTM candidate cell, the BWP ID field is ignored and set to 0. Otherwise (i.e., if LTM is configured by the higher layer and the LTM indication field indicates that the MAC CE 500 is used for a serving cell, or if LTM is not configured by the higher layer), the BWP ID field indicates a UL BWP for which the MAC CE applies as the codepoint of the DCI bandwidth part indicator field as specified in TS 38.212. The length of the BWP ID field is 2 bits.

The Sᵢ field indicates that an activation/deactivation status of the Semi-Persistent CSI report configuration within ltm-CSI-ReportConfigToAddModList, if the LTM indication field indicates that the MAC CE 500 is used for an LTM candidate cell. For example, the S₀ field refers to a report configuration which includes PUCCH resources for SP CSI reporting for the LTM candidate cell and has the lowest LTM-CSI-ReportConfigId within the list with type set to semiPersistentOnPUCCH. The Sᵢ field refers to the report configuration which includes PUCCH resources for SP CSI reporting for the LTM candidate cell and has the second lowest LIM-CSI-ReportConfigId, and this pattern continues. If the number of report configurations within the list with type set to semiPersistentOnPUCCH in the indicated BWP is less than i+1, the MAC entity shall ignore the Sᵢ field. The Sᵢ field is set to 1 to indicate that the corresponding Semi-Persistent CSI report configuration shall be activated. The Sᵢ field is set to 0 to indicate that the corresponding Semi-Persistent CSI report configuration i shall be deactivated. Otherwise (i.e., if LTM is configured by the higher layer and the LTM indication field indicates that the MAC CE 500 is used for the serving cell, or if LTM is not configured by the higher layer), this field indicates the activation/deactivation status of the Semi-Persistent CSI report configuration within csi-ReportConfigToAddModList. For example, the S₀ field refers to a report configuration which includes PUCCH resources for SP CSI reporting in the indicated BWP and has the lowest CSI-ReportConfigId within the list with type set to semiPersistentOnPUCCH. The Sᵢ field refers to the report configuration which includes PUCCH resources for SP CSI reporting in the indicated BWP and has the second lowest CSI-ReportConfigId, and this pattern continues. If the number of report configurations within the list with type set to semiPersistentOnPUCCH in the indicated BWP is less than i+1, the MAC entity ignores the Sᵢ field. The Sᵢ field is set to 1 to indicate that the corresponding Semi-Persistent CSI report configuration is activated. The Sᵢ field is set to 0 to indicate that the corresponding Semi-Persistent CSI report configuration is deactivated. The R bits are set to 0.

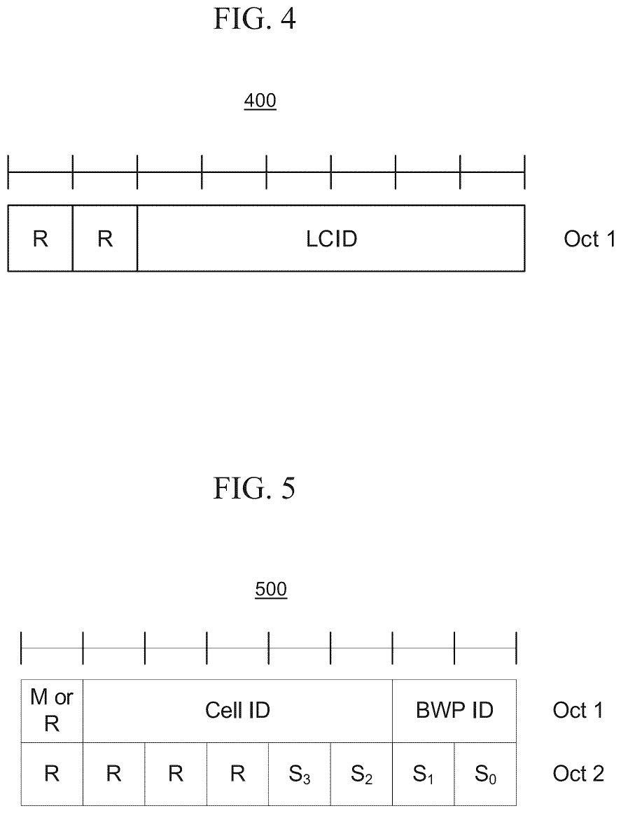

FIG. 6 shows another example of SP CSI reporting on PUCCH Activation/Deactivation MAC CE 600 in accordance with an embodiment.

The SP CSI reporting on PUCCH Activation/Deactivation MAC CE 600 may be identified by a MAC subheader with LCID 400 in FIG. 4. In an embodiment, the LCID for SP CSI reporting on PUCCH Activation/Deactivation MAC CE is specified by codepoint/index 51 in Table 4.

Referring to FIG. 6, the SP CSI reporting on PUCCH Activation/Deactivation MAC CE 600 has a fixed size of 16 bits and includes an M field, a Cell ID field, a BWP ID field, MSᵢ fields, and Sᵢ fields.

The M field indicates whether the MAC CE 600 is used for SP CSI reporting on PUCCH Activation/Deactivation for a serving cell or for an LTM candidate cell. If LTM is configured by higher layer, this field is set to 1 to indicate that the MAC CE 600 is used for SP CSI reporting on PUCCH Activation/Deactivation for an LTM candidate cell indicated by the Cell ID field. Otherwise, this field is set to 0 to indicate that the MAC CE 600 is used for SP CSI reporting on PUCCH Activation/Deactivation for a serving cell indicated by the Cell ID field. If LTM is not configured by higher layer, a R bit is present instead. The length of this field is 1 bit. The M field can be referred to ‘LTM indication field’ in this disclosure.

The Cell ID field identifies the cell for which the MAC CE 600 applies. The length of the field is 5 bits. If the LTM indication field indicates that the MAC CE 600 is used for an LTM candidate cell, the 3 LSB of this field indicates a LTM candidate cell identity, corresponding to Itm-CandidateId minus 1 as specified in TS 38.331, for which the MAC CE 600 applies. In this case, the 2 MSB of this field are set to 0. Otherwise (i.e., if LTM is configured by the higher layer and the LTM indication field indicates that the MAC CE 600 is used for the serving cell, or if LTM is not configured by the higher layer), the Cell ID field indicates the serving cell identity with 5 bits for which the MAC CE 600 applies.

The BWP ID field is ignored and set to 0 if the LTM indication field indicates that the MAC CE 600 is used for an LTM candidate cell. Otherwise (i.e., if LTM is configured by the higher layer and the LTM indication field indicates the MAC CE 600 is used for the serving cell, or if LTM is not configured by the higher layer), this field indicates a UL BWP for which the MAC CE 600 applies as the codepoint of the DCI bandwidth part indicator field as specified in TS 38.212. The length of the BWP ID field is 2 bits.

The Sᵢ field is ignored and set to 0 if the LTM indication field indicates that the MAC CE 600 is used for an LTM candidate cell. Otherwise (i.e., if LTM is configured by the higher layer and the LTM indication field indicates that the MAC CE 600 is used for the serving cell, or if LTM is not configured by the higher layer), this field indicates an activation/deactivation status of the Semi-Persistent CSI report configuration within csi-ReportConfigToAddModList, as specified in TS 38.331. For example, the S₀ field refers to a report configuration which includes PUCCH resources for SP CSI reporting in the indicated BWP and has the lowest CSI-ReportConfigId within the list with type set to semiPersistentOnPUCCH. The Sᵢ field refers to a report configuration which includes PUCCH resources for SP CSI reporting in the indicated BWP and has the second lowest CSI-ReportConfigId, and this pattern continues. If the number of report configurations within the list with type set to semiPersistentOnPUCCH in the indicated BWP is less than i+1, the MAC entity ignores the Sᵢ field. The Sᵢ field is set to 1 to indicate that the corresponding Semi-Persistent CSI report configuration is activated. The Sᵢ field is set to 0 to indicate that the corresponding Semi-Persistent CSI report configuration is deactivated.

The MSᵢ field indicates an activation/deactivation status of the Semi-Persistent CSI report configuration within ltm-(′SI-ReportConfigToAddModList if LTM indication field indicates the MAC CE 600 is used for an LTM candidate cell. For example, the MS₀ field refers to a report configuration which includes PUCCH resources for SP CSI reporting for the LTM candidate cell and has the lowest LTM-CSI-ReportConfigId within the list with type set to semiPersistentOnPUCCH. The MS₁ field refers to a report configuration which includes PUCCH resources for SP CSI reporting for the LTM candidate cell and has the second lowest LIM-CSI-ReportConfigId, and this pattern continues. If the number of report configurations within the list with type set to semiPersistentOnPUCCH in the indicated BWP is less than i+1, the MAC entity ignores the MSᵢ field. The MSᵢ field is set to 1 to indicate that the corresponding Semi-Persistent CSI report configuration is activated. The MSᵢ field is set to 0 to indicate that the corresponding Semi-Persistent CSI report configuration is deactivated. Otherwise (i.e., if LTM is configured by the higher layer and the LTM indication field indicates the MAC CE 600 is used for the serving cell, or if LTM is not configured by the higher layer), a R bit is present instead, or this field is ignored and set to 0. The R bit is set to 0.

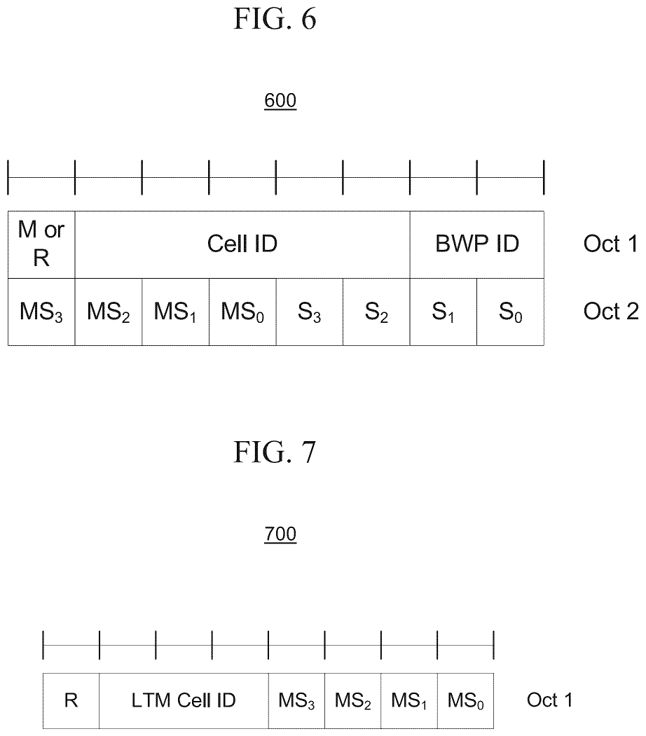

FIG. 7 shows an example of an LTM SP CSI reporting on PUCCH Activation/Deactivation MAC CE 700 in accordance with an embodiment. The LTM SP CSI reporting on PUCCH Activation/Deactivation MAC CE 700 may be identified by a MAC subheader with a new LCID 400 in FIG. 4. In an embodiment, the LCID for the LTM SP CSI reporting on PUCCH Activation/Deactivation MAC CE 700 is specified with codepoint/index 46. In Table 5.

TABLE 5

| Codepoint/Index | LCID values |
|---|---|
| 0 | CCCH |
| 1-32 | Identity of the logical channel of DCCH, DTCH and |
| | multicast MTCH |
| 33 | Extended logical channel ID field (two-octet eLCID |
| | field) |
| 34 | Extended logical channel ID field (one-octet eLCID |
| | field) |
| 35-45 | Reserved |
| 46 | LTM SP CSI reporting on PUCCH |
| | Activation/Deactivation |
| 47 | Recommended bit rate |
| 48 | SP ZP CSI-RS Resource Set Activation/Deactivation |
| 49 | PUCCH spatial relation Activation/Deactivation |
| 50 | SP SRS Activation/Deactivation |
| 51 | SP CSI reporting on PUCCH Activation/Deactivation |
| 52 | TCI State Indication for UE-specific PDCCH |
| 53 | TCI States Activation/Deactivation for UE-specific |
| | PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

Referring to FIG. 7, the LTM SP CSI reporting on PUCCH Activation/Deactivation MAC CE 700 has a fixed size of 8 bits and includes an R field, an LTM Cell ID field, and MSᵢ fields.

The LTM Cell ID identifies the LTM candidate cell for which the MAC CE 700 applies, corresponding to ltm-CandidateId minus 1. The length of the field is 3 bits.

The MSᵢ field indicates an activation/deactivation status of the Semi-Persistent CSI report configuration within ltm-CSI-ReportConfigToAddModList. For example, the MS₀ field refers to a report configuration which includes PUCCH resources for SP CSI reporting for the LTM candidate cell and has the lowest LTM-CSI-ReportConfigId within the list with type set to semiPersistentOnPUCCH. The MS₁ refers to a report configuration which includes PUCCH resources for SP CSI reporting for the LTM candidate cell and has the second lowest LIM-CSI-ReportConfigId, and this pattern continues. If the number of report configurations within the list with type set to semiPersistentOnPUCCH in the indicated BWP is less than i+1, the MAC entity ignores the MSᵢ field. The MSᵢ field is set to 1 to indicate that the corresponding Semi-Persistent CSI report configuration is activated. The MSᵢ field is set to 0 to indicate that the corresponding Semi-Persistent CSI report configuration is deactivated. The R bit is set to 0.

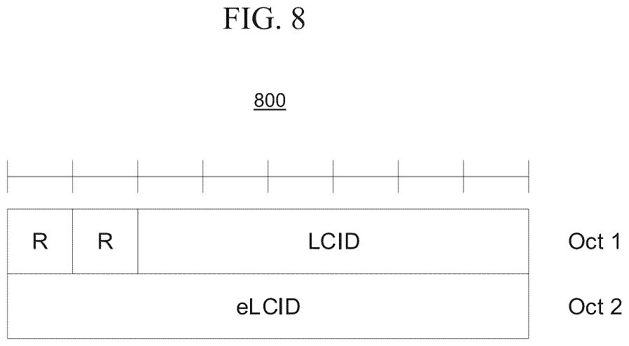

FIG. 8 shows another example MAC subheader with a new eLCID 800 in accordance with an embodiment. In some embodiments, the LTM SP CSI reporting on PUCCH Activation/Deactivation MAC CE 700 in FIG. 7 is identified by the MAC subheader 800 with a new eLCID in FIG. 8.

Referring to FIG. 8, the MAC subheader 800 includes R bits, and an LCID field, an Elcid field. The R bits and the LCID field are similar to, or the same as, those in FIG. 4. In an embodiment, the eLCID for LTM SP CSI reporting on PUCCH Activation/Deactivation MAC CE 700 is specified with a reserved codepoint of 226 and a reserved index of 290 in Table 6.

TABLE 6

| Codepoint | Index | LCID values |
|---|---|---|
| 0 to 225 | 64 to 289 | Reserved |
| 226 | 290 | LTM SP CSI reporting on PUCCH |
| | | Activation/Deactivation |
| 227 | 291 | Serving Cell Set based SRS TCI State |
| | | Indication MAC CE |
| 228 | 292 | SP/AP SRS TCI State Indication |
| | | MAC CE |
| 229 | 293 | BFD-RS Indication MAC CE |
| 230 | 294 | Differential Koffset |
| 231 | 295 | Enhanced SCell |
| | | Activation/Deactivation MAC CE |
| | | with one octet Cᵢ field |
| 232 | 296 | Enhanced SCell |
| | | Activation/Deactivation MAC CE |
| | | with four octet Cᵢ field |
| 233 | 297 | Unified TCI States |
| | | Activation/Deactivation MAC CE |
| 234 | 298 | PUCCH Power Control Set Update for |
| | | multiple TRP PUCCH repetition MAC |
| | | CE |
| 235 | 299 | PUCCH spatial relation |
| | | Activation/Deactivation for multiple |
| | | TRP PUCCH repetition MAC CE |
| 236 | 300 | Enhanced TCI States Indication for |
| | | UE-specific PDCCH |
| 237 | 301 | Positioning Measurement Gap |
| | | Activation/Deactivation Command |
| 238 | 302 | PPW Activation/Deactivation |
| | | Command |
| 239 | 303 | DL Tx Power Adjustment |
| 240 | 304 | Timing Case Indication |
| 241 | 305 | Child IAB-DU Restricted Beam |
| | | Indication |
| 242 | 306 | Case-7 Timing advance offset |
| 243 | 307 | Provided Guard Symbols for Case-6 |
| | | timing |
| 244 | 308 | Provided Guard Symbols for Case-7 |
| | | timing |
| 245 | 309 | Serving Cell Set based SRS Spatial |
| | | Relation Indication |
| 246 | 310 | PUSCH Pathloss Reference RS |
| | | Update |
| 247 | 311 | SRS Pathloss Reference RS Update |
| 248 | 312 | Enhanced SP/AP SRS Spatial Relation |
| | | Indication |
| 249 | 313 | Enhanced PUCCH Spatial Relation |
| | | Activation/Deactivation |
| 250 | 314 | Enhanced TCI States |
| | | Activation/Deactivation for UE- |
| | | specific PDSCH |
| 251 | 315 | Duplication RLC |
| | | Activation/Deactivation |
| 252 | 316 | Absolute Timing Advance Command |
| 253 | 317 | SP Positioning SRS |
| | | Activation/Deactivation |
| 254 | 318 | Provided Guard Symbols |
| 255 | 319 | Timing Delta |

In another embodiment, the activation of semi-persistent CSI report on PUCCH for LTM can be configured by RRC. If an LTM CSI report is configured with type semiPersistentOnPUCCH in LTM-CSI-ReportConfig, a 1-bit RRC parameter (e.g., Activate-SemiPersistentOnPUCCH) can be introduced to indicate whether the report is activated or not. When this parameter set to “enable,” it indicates that the report is activated. If the parameter is absent, it indicates that the report is deactivated.

In some embodiments, when L3 (conditional) handover is failed, the UE may:
1> if timer T304 of the Master Cell Group (MCG) expires:
   2>release dedicated preambles provided in rach-ConfigDedicated if configured;
   2>release dedicated msgA PUSCH resources provided in rach-ConfigDedicated if configured;
   2> if rach-LessHO was included in reconfigurationWithSync and cg-NTN-RACH-Less-Configuration was configured:
      3>release the uplink grant configured for RACH-less handover in cg-NTN-RACH-Less-Configuration.

In some embodiments, when L3 (conditional) handover is failed, the UE may:
1> if timer T304 of the MCG expires; or
1> if timer T420 timer expires; or,
1> if the target L2 U2N Relay UE (i.e., the UE indicated by targetRelayUE-Identity in the received RRCReconfiguration message containing reconfigurationWithSync indicating path switch) changes its serving PCell before path switch:
   2>release dedicated preambles provided in rach-ConfigDedicated if configured;
   2>release dedicated msgA PUSCH resources provided in rach-ConfigDedicated if configured;
   2>release rach-LessHO if configured; and/or
   2>release beam indication (tci-StateID and/or dg-beam) in rach-lessHO if configured; and/or
   2>release the configured uplink grant for rach-less HO (e.g., in cg-RACH-Less-Configuration) if configured.

In some embodiments, for satellite switch with resynchronization and PCI unchanged, upon receiving SIB19 in an NTN cell, the UE in RRC_CONNECTED may:
1> if SatSwitchWithReSync and t-Service are included, and the UE supports hard satellite switch with re-synchronization:
   2> if t-ServiceStart is included and the UE supports soft satellite switch with resynchronization:
      3> perform the procedure of satellite switch with resynchronization and PCI unchanged between the time indicated by t-ServiceStart and the time indicated by t-Service for the serving cell;
   2> else:
      3> perform the procedure of satellite switch with resynchronization and PCI unchanged at the time indicated by t-Service for the serving cell.

When performing a satellite switch with resynchronization and PCI unchanged, if UE supports DL synchronization with the target satellite while remaining connected to the source satellite, the UE may perform DL synchronization with the target satellite before disconnecting to the source satellite. After the satellite switch with resynchronization and PCI unchanged, UE may acquire SIB19 of the serving cell.

In some embodiments, a satellite switch procedure with resynchronization may be specified as follows. The UE shall:
1> If the current time is between the time indicated by t-ServiceStart and the time indicated by t-Service for the serving cell, and
1> If UE supports to perform DL synchronization with the satellite indicated by ntn-Config in SatSwitchWithReSync while at the same time connecting to the current source satellite for soft satellite switch with resynchronization,
   2> start re-synchronizing to the DL of the SpCell served by the satellite indicated by ntn-Config in SatSwitchWithReSync;
   2> if synchronization to the DL of the SpCell served by the satellite indicated by ntn-Config in SatSwitchWithReSync is obtained/completed,
      3>stop timer T430 if running;
      3>inform lower layers that UL synchronization is lost due to satellite switch with re-synchronization;
      3> start timer T430 with the timer value set to ntn-UlSyncValidityDuration from the subframe indicated by epochTime in ntn-Config in SatSwitchWithReSync;
      3>inform lower layers when UL synchronization is obtained;
1> else:
   2>stop timer T430 if running;
   2>inform lower layers that UL synchronisation is lost due to satellite switch with re-synchronization;
   2> start re-synchronising to the DL of the SpCell served by the satellite indicated by ntn-Config in SatSwitchWithReSync;
   2> if synchronization to the DL of the SpCell served by the satellite indicated by ntn-Config in SatSwitchWithReSync is obtained/completed, 3> start timer T430 with the timer value set to ntn-UlSyncValidityDuration from the subframe indicated by epochTime in ntn-Config in SatSwitchWithReSync; 3>inform lower layers when UL synchronization is obtained;
In some embodiments, a satellite switch procedure with resynchronization may be specified as follows. The UE may:
1> If the current time is at or after the indicated by t-Service:
   2>stop timer T430 if running;
   2>inform lower layers that UL synchronization is lost due to satellite switch with re-synchronization;
1> start re-synchronizing to the DL of the SpCell served by the satellite indicated by ntn-Config in SatSwitchWithReSync;
1> if synchronization to the DL of the SpCell served by the satellite indicated by ntn-Config in SatSwitchWithReSync is obtained/completed,
   2> if timer T430 is running:
      3>stop timer T430;
      3>inform lower layers that UL synchronization is lost due to satellite switch with re-synchronization;
   2> start timer T430 with the timer value set to ntn-UlSyncValidityDuration from the subframe indicated by epochTime in ntn-Config in SatSwitchWithReSync;
   2>inform lower layers when UL synchronization is obtained.

In some embodiments, a satellite switch procedure with resynchronization may be specified as follows. The UE may:
1> If the current time is at or after the indicated by t-Service:
   2>stop timer T430 if running;
   2>inform lower layers that UL synchronization is lost due to satellite switch with re-synchronization;
1> start re-synchronizing to the DL of the SpCell served by the satellite indicated by ntn-Config in SatSwitchWithReSync;
1> if synchronization to the DL of the SpCell served by the satellite indicated by ntn-Config in SatSwitchWithReSync is obtained/completed,
   2>stop timer T430 if running;
   2> start timer T430 with the timer value set to ntn-UlSyncValidityDuration from the subframe indicated by epochTime in ntn-Config in SatSwitchWithReSync;
   2>inform lower layers when UL synchronization is obtained.

In some embodiments, a satellite switch procedure with resynchronization may be specified as follows. The UE may:
1> If the current time is between the time indicated by t-ServiceStart and the time indicated by t-Service for the serving cell, and
1> If UE supports to perform DL synchronization with the satellite indicated by ntn-Config in SatSwitchWithReSync while at the same time connecting to the current source satellite for soft satellite switch with resynchronization,
   2> start re-synchronizing to the DL of the SpCell served by the satellite indicated by ntn-Config in SatSwitchWithReSync;
   2> if synchronization to the DL of the SpCell served by the satellite indicated by ntn-Config in SatSwitchWithReSync is obtained/completed,
      3>stop timer T430 if running;
      3> start timer T430 with the timer value set to ntn-UlSyncValidityDuration from the subframe indicated by epochTime in ntn-Config in SatSwitchWithReSync;
      3>inform lower layers when UL synchronization is obtained.
1> else:
   2>stop timer T430 if running;
   2>inform lower layers that UL synchronisation is lost due to satellite switch with re-synchronization;
   2> start re-synchronising to the DL of the SpCell served by the satellite indicated by ntn-Config in SatSwitchWithReSync;
   2> if synchronization to the DL of the SpCell served by the satellite indicated by ntn-Config in SatSwitchWithReSync is obtained/completed,
      3> start timer T430 with the timer value set to ntn-UlSyncValidityDuration from the subframe indicated by epochTime in ntn-Config in SatSwitchWithReSync;
      3>inform lower layers when UL synchronization is obtained.

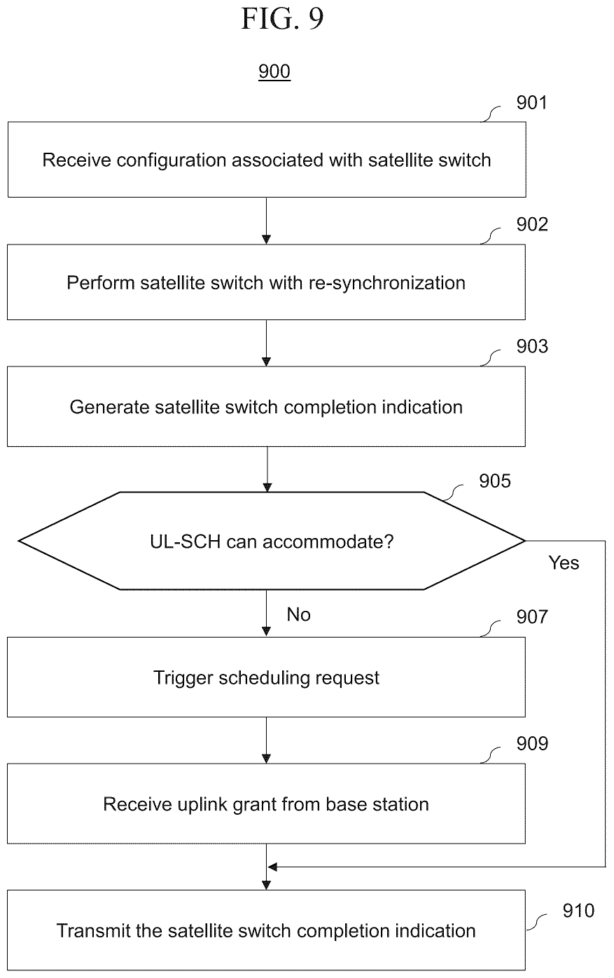

FIG. 9 shows an example process 900 for a satellite switch with re-synchronization in accordance with an embodiment. For explanatory and illustration purposes, the example process 900 may be performed by an UE. Although one or more operations are described or shown in particular sequential order, in other embodiments the operations may be rearranged in a different order, which may include performance of multiple operations in at least partially overlapping time periods.

Referring to FIG. 9, the process 900 may begin in operation 901. In operation 901, UE receives, from a base station, a configuration associated with a satellite switch. In an embodiment, the configuration may include information required for the satellite switch from a source satellite to a target satellite.

In operation 902, UE performs the satellite switch with re-synchronization from a source satellite to a target satellite based on the configuration received from the base station.

In operation 903, UE generates a satellite switch completion indication. In an embodiment, the satellite switch completion indication may be a TA report for the target satellite. In another embodiment, the satellite switch completion indication may be a MAC CE which is identified by a LCID or an eLCID. As discussed above, it can be a Satellite Switch with Re-sync Completion Report MAC CE. In some embodiments, an MAC entity of the UE may trigger a TA report when an indication of uplink synchronization is received after indication of uplink synchronization loss due to satellite switch with re-synchronization.

In operation 905, UE determines whether UL-SCH resources can accommodate the satellite switch completion indication. When UL-SCH resources can accommodate the indication, the process 900 proceeds to operation 910. Otherwise, the process 900 proceeds to operation 907.

In operation 907, UE triggers and transmits a scheduling request for the satellite switch completion indication to a base station.

In operation 909, in response to the scheduling request, UE receives an uplink grant for the satellite switch completion indication from a base station.

In operation 910, UE transmits the satellite switch completion indication to the base station.

The present disclosure provides various embodiments for UE to report a satellite switch completion to the network. Therefore, the network is informed that UE has successfully completed the satellite switch and can begin scheduling the UE from the new satellite.

The present disclosure provides various embodiments of signaling to activate semi-persistent CSI reporting on PUCCH for LTM, enabling UE to perform DL synchronization with a target satellite before stopping communication with a source satellite in the satellite switch procedure with re-synchronization.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to receive, from a base station, a configuration associated with a satellite switch;
a processor operably coupled to the transceiver, the processor configured to:
perform the satellite switch with re-synchronization from a source satellite to a target satellite based on the configuration; and
generate a satellite switch completion indication,
wherein the transceiver is further configured to transmit, to the base station, the satellite switch completion indication.

2. The UE of claim 1, wherein the satellite switch completion indication is generated based on a determination that uplink synchronization is obtained for the target satellite due to the satellite switch with re-synchronization.

3. The UE of claim 1, wherein:
the processor is further configured to trigger a scheduling request based on a determination that an uplink shared channel resource does not accommodate the satellite switch completion indication; and
the transceiver is further configured to transmit, to the base station, the scheduling request.

4. The UE of claim 1, wherein the satellite switch completion indication is a timing advance report.

5. The UE of claim 1, wherein the satellite switch completion indication is included in a medium access control (MAC) control element (CE) that is identified by a logical channel identifier or an extended logical channel identifier of a MAC subheader.

6. The UE of claim 5, wherein the transceiver is further configured to transmit the MAC CE in a prioritized logical channel.

7. The UE of claim 1, wherein the satellite switch completion indication is generated based on a determination that a difference in a timing advance value from a last timing advance report is larger than an offset value.

8. The UE of claim 1, wherein the transceiver is further configured to receive an indication from the base station via a radio resource control (RRC) signaling, the indication enabling transmission of the satellite switch completion indication.

9. A base station (BS) for facilitating communication in a wireless network, the BS comprising:
a processor configured to generate a configuration associated with a satellite switch; and
a transceiver operably coupled to the processor, the transceiver configured to:
transmit, to a user equipment (UE), the configuration; and
receive, from the UE, a satellite switch completion indication indicating that the satellite switch with re-synchronization from a source satellite to a target satellite is completed.

10. The BS of claim 9, wherein the satellite switch completion indication indicates that uplink synchronization is obtained for the target satellite due to the satellite switch with re-synchronization.

11. The BS of claim 9, wherein the transceiver is further configured to receive, from the UE, a scheduling request for accommodating the satellite switch completion indication.

12. The BS of claim 9, wherein the satellite switch completion indication is a timing advance report.

13. The BS of claim 9, wherein the satellite switch completion indication is included in a medium access control (MAC) control element (CE) that is identified by a logical channel identifier or an extended logical channel identifier of a MAC subheader.

14. The BS of claim 13, wherein the transceiver is further configured to receive the MAC CE in a prioritized logical channel.

15. The BS of claim 9, wherein the satellite switch completion indication indicates that a difference in a timing advance value from a last timing advance report is larger than an offset value.

16. The BS of claim 9, wherein the transceiver is further configured to transmit an indication to the UE via radio resource control (RRC) signaling, the indication enabling transmission of the satellite completion indication by the UE.

17. A method performed by a user equipment (UE) in a wireless network, the method comprising:
receiving, from a base station, a configuration associated with a satellite switch;
performing the satellite switch with re-synchronization from a source satellite to a target satellite based on the configuration;
generating a satellite switch completion indication; and
transmitting, to the base station, the satellite switch completion indication.

18. The method of claim 17, wherein the satellite switch completion indication is generated based on a determination that uplink synchronization is obtained for the target satellite due to the satellite switch with re-synchronization.

19. The method of claim 17, further comprising transmitting a scheduling request based on a determination that an uplink shared channel resource does not accommodate the satellite switch completion indication.

20. The method of claim 17, wherein the satellite switch completion indication is generated based on a determination that a difference in a timing advance value from a last timing advance report is larger than an offset value.
